(19) United States
(12) Patent Application Publication
(10) Pub. No.: US 2011/0231011 A1
(43) Pub. Date: Sep. 22, 2011

(54) Distributed system of electronically controlled and monitored containment systems for the management and handling of solid and liquid material.

(76) Inventor: Brenda Bagavathi Powers, Alameda, CA (US)

(21) Appl. No.: 12/728,267

(22) Filed: Mar. 21, 2010

(51) Int. Cl. G06F 17/00

(52) U.S. Cl. 700/236

(57) ABSTRACT

A scalable system for monitoring a collection of electronically enabled containers which can hold solid or liquid material. Containers are built into the surface of a framework which provides electronic and software support. Containers are programmed with a time of day value for generating a notification and sending messages for handling container material at specified time intervals such as when to remove, add, mix material, for example. The system may be contained within one physical framework or spread across multiple frameworks to form a network. The invention is scalable from a single standalone device to a networked system of multiple frameworks. The invention provides improvements over existing designs by using networking technology, a database system for container and user information, a logging system for all activities and a scalable architecture.

### BACKGROUND OF THE INVENTION

1. Scope of Invention

This invention pertains to timed management of material for handling of chemical and biological specimens, pills, liquids or other solid or liquid material which can be managed within the physical confines of the invention. The invention services the needs of a single individual in the case of a standalone design or a larger environment using a distributed design incorporating networking technologies.

2. Description of Prior Art

In the arena of human consumption of prescription substances as well as non-prescription substances such as vitamins, minerals, homeopathic material and over the counter medications there is a wide variety of technologies available to remind the individual of the dosage and time of administering of the substance(s). Several particular problems arise with the taking of prescription or non-prescription substances such as: (1) missed time (2) taking the wrong substance(s) (3) taking too much of a substance(s) (4) taking substance(s) at the wrong time (5) taking substance(s) in the wrong combination (6) loosing the substance(s) altogether and thus failing to take the substance(s) entirely (7) missing medications because of lost or misplaced Rx vials (8) taking outdated medications because of too many old medications mixed with current/proper medications (9) single user stand alone systems (10) poor security (11) failure to comply with HIPA requirements regarding patient information (12) single market designs (13) designs oriented only for the elderly (14) designs oriented only for prescription medication.

In the home environment the user/patient is responsible for the taking of the substance(s) or a family member or assigned care giver is given the responsibility for the administering of prescription medical substance(s). The proper administering of prescription substance(s) is thus more critical and demands greater attention to prescription drugs, over-the-counter medications and their proper time of administering, quantity and record keeping.

In the home environment where non-prescription substance(s) are in use such as supplements and homeopathic remedies and there is no danger of wrong dosage or a wrong combination of substance(s). There is the problem of storage of the substance(s) as well as the personal satisfaction of the user in taking an active part in administering to their own current state of health. Many people take supplements and homeopathic substance(s) as religiously as prescription medications and need a similar technology for the proper dosage, timed dispensing and storage of substance(s).

In the environment of managed care where there is a small household of patients being attended to by an LVN or RN or where an LVN or RN is administering care to patient(s) in the patient(s) own home, the management of prescription medications is critical as to: (1) proper administering of medication(s) at designated times (2) administering proper dosages (3) administering proper combinations of medications (4) keeping the medications away from the patient(s) and unauthorized personnel (5) administering medications to the proper patient and not mixing medications between patients (6) keeping accurate records of the patients, their medications, dosage of medication(s) and time of administering medication(s) to comply with HIPA requirements and (7) storage and distribution of medications.

All of the above situations are also found within the industry of animal care and research. In the veterinary profession as well as within the research laboratory where animals are used for scientific research proper administering of animal prescription medications as well as vitamins/minerals and homeopathic substance(s) is as necessary for proper animal health. Within these environments the management of prescription medication(s) and supplements is critical for the same reasons as described in the environment for human care.

Proper substance handling is also necessary in the laboratory for the handling of chemical and biological substances. Both environments require the (1) storage of material prior to handling (2) storage of material in either an elevated temperature environment or an environment with a lower temperature (3) mixing of material in correct amounts (4) timed handling of material prior to or after mixing (5) security of material from unauthorized personnel (6) record keeping of when material was handled.

For ease of understanding, the above environments can be grouped into two classifications: (1) drug administering class (2) non-drug handling class. The drug administering class consists of all substances which include: (1) prescription substances for both human and non-human use (2) supplements such as vitamins and minerals for both human and non-human use (3) over the counter medications for both human and non-human use (4) experimental substances for both human and non-human use. The drug administering class consists of human clinical and non-clinical (home) environments as well as animal (pet care, veterinary, animal research) environments. The non-drug handling class consists of chemical material as well as biological material. The non-drug handling environments consist of: (1) student classrooms (2) research laboratories for both chemical and biological sciences (3) health care clinical laboratories for both research (4) health care clinical laboratories for handling patient biological specimens.

For the drug administering class, prior art has only several technologies all of which fall short of meeting the needs of the patient and the patient care-giver in the use of prescription medication and the user of non-prescription substances both for human and non-human use. The user has a choice of only two basic technologies all others being variations of more or less sophistication but failing to meet all the requirements for a proper handling system.

One technology is a non-electronic storage system consisting of a series of compartments of various sizes and shapes with a lid to cover the compartments. Some devices have days of the week marked for each compartment and some have no markings. The user must distribute the substances into each compartment manually. Compartments can hold a limited number of pills. Compartments are not designed to hold liquid based medications. Compartments do not have an adequate method for labeling the contents of each compartment. There is no system of setting: (1) the dosage (2) time of dispensing (3) what medications to take in combination. The user must be responsible for determining: (1) what medications to take at what time (2) what combinations of medications to take (3) what dosage of medication(s) to take (4) finding an alternative time keeping method (4) remembering what medications to take at what time. There is also no system to store the medications prior to dosing them out into the compartments thus creating the situation of loosing medications or using out of date medications. The user must also keep mental or written records of what medications to take, at what time, at what day of week as well as when medications were taken. Record keeping is important for professional health care providers. These systems are only designed for the dispensing of prescription medical products and lack any generic material handling capability or messaging system.

The second system is an electronic system which automates some activities the patient or care giver would have to do with the non-electronic system. These come in two basic varieties. First, is a simple electronic reminder system similar to a watch alarm? Such a system may be attached to a medication vial such that when the alarm is activated the user takes the medication in the vial. This is limited to one medication and has the failure of (1) no record keeping (2) limited to one medication (3) the user must fill the vial manually (4) wrong medication can be inserted into the vial. These systems serve a limited market and work only when a single medication and single dose is required. The systems are only intended for use by humans, especially the elderly, for handling prescription medications. These systems are only designed for the dispensing of prescription medical products and lack any generic material handling capability or messaging system and are intended for the elderly.

A second variety of electronic remainder system consists of a series of compartments similar to the non-electronic version but having an alarm associated with each compartment. When the alarm sounds the user takes the medication from a single compartment. These systems solve some of the failings of the non-electronic system and the single-dose system but still suffer from (1) manually filling of each compartment periodically (2) difficult to take multiple medications due to limited compartment size (3) fixed size and shape of compartments (4) correct dosages must be manually done (5) no record keeping (6) no security of patient information as per-HIPA requirements (7) user can still fill a compartment with an out of date medication (8) there is no way to store the proper medications for easy access at dispensing time (9) lack of ability to expand the number of compartments (10) lack of remote processing ability for larger environments (11) designed primarily for the home environment (12) designed for a single user (13) lack any ability to expand to meet larger clinical/non-clinical environments (14) designed with only the elderly taking prescription medications in mind. These systems are only designed for the dispensing of prescription medical products and lack any generic material handling capability or messaging system and are intended for the elderly.

There is no product which allows for expansion of containers from a simple stand alone system into larger systems to serve ever larger environments and multiple users. This leaves a void for the small health care clinics, nursing homes, group homes as well as the industry of pet care, animal research and laboratory environments for management of medications and supplements and laboratory material. The existing systems also are oriented specifically for the dispensing of medications and have no generic material handling capability to serve a more diverse market.

For the non-drug handling class there is insufficient prior art to address the problems of proper substance handling necessary in the laboratory for chemical and biological substances. Both environments require the (1) storage of material prior to handling (2) storage of material in either an elevated temperature environment or an environment with a lower temperature (3) mixing of material in correct amounts (4) timed handling of material prior to or after mixing (5) security of material from unauthorized personnel (6) record keeping of when material was handled. Current techniques for small health care environments, animal care environments and laboratory environments consists of manual record keeping, external time keeping devices for setting alarms, simple container holding systems for test tubes or larger containers.

| Patent Number | Publication Date | Name of Patentee |
|---|---|---|
| D383668 | Sep. 16, 1997 | Siegel, et al. |
| D279551 | Jul. 09, 1985 | Claytor, III |
| D563095 | Mar. 04, 2008 | Sabbag |
| D311340 | Oct. 16, 1990 | Armstrong |
| D298416 | Nov. 08, 1988 | Rakocy |
| D537734 | Mar. 06, 2007 | Wolpow |
| D528434 | Sep. 19, 2006 | Wolpow |
| D276998 | Jan. 01, 1985 | Caven |
| 7,147,127 | Dec. 12, 2006 | Lepke, et al. |
| 6,169,707 | Jan. 02, 2001 | Newland |
| 7,587,259 | Sep. 08, 2009 | Berg |
| 7,584,849 | Sep. 08, 2009 | Mauk |
| 7,575,003 | Aug. 18, 2009 | Rasmussen, et al. |
| 7,571,811 | Aug. 11, 2009 | Mulaw |
| 7,596,925 | Oct. 06, 2009 | Yuyama, et al. |
| 7,543,718 | Jun. 09, 2009 | Simon |
| 6,550,618 | Apr. 22, 2003 | Peterson |
| 6,068,158 | May 30, 2000 | Chabout |
| 4,124,143 | Nov. 07, 1978 | Thomas |

Prior art suffers from the problems of (1) single user stand alone systems (2) poor security (3) failure to comply with HIPA requirements regarding patient information (4) single market designs (5) designs oriented only for the elderly (6) designs oriented only for prescription medication (7) lack of flexibility in container size and shape (8) lack of record keeping ability. Prior art is also limited to the storage of a variety of objects of varying sizes while my invention can store a variety of material types of any size and shapes as well as objects without separate containers such as but not limited to (1) medication vials of a variety of sizes (2) non-medication containers (3) laboratory containers such as test tubs and beakers (4) solid material not within a physical container.

The present invention supersedes prior art by integrating container activity, programming of user information, messaging and notification, remote and local control and monitoring, privacy and security, logging and reporting and networking technology into a flexible system that can expand to meet the needs of multiple markets and end use environments. While prior art focuses on standalone hardware for single users, my invention revolves around the use of flexible container frameworks and software to take advantage of simplistic off the shelf hardware components to craft uniqueness into the invention for a variety of markets and end applications. Prior art designed around simple standalone hardware are self limiting due to the inflexibility of such hardware based designs and simple hardware controlling software. Prior art uses software as an enabler of the hardware but does not surpass the hardware in terms of functionality. The use of more powerful software by this invention enables the system to be expanded to be used in the higher demanding clinical environments as well as non-clinical environments while keeping the cost down through simplistic off the shelf hardware. Prior art is self-limiting because it is focused on the dispensing of medication by a single user over a specific age. My invention treats the contents of the compartments uniquely based on the selection of material type chosen by the user thus allowing for a variety of material besides medication and a market of users not based on age and/or physical and/or mental capacity or incapacity. Prior art also is self-limiting because its messaging system is a simplistic set of messages to take a medication at prearranged times. My invention allows for the entry of complex messages and commands suitable to a laboratory environment where material handling is more complex than the taking of a pill. My invention also allows for the entry of messages and notifications unrelated to the status of a compartment and its contents thus expanding its capability into more environments. My invention can be used in all its designated environments simultaneously by the use of remotely attached compartment frameworks and the use of customized messages and notifications. My invention can be programmed for any type of notification event unrelated to the containers. Such notifications are useful when it is necessary to remind the user about any type of event such as appointments, a wake up alarm, etc. as well as giving the user complex instructions regarding how to manage material within container(s) such as mixing material, material temperatures, etc. which is beyond the simple actions of taking a pill. My invention also is suitable for laboratory environments where a refrigerated or elevated temperature environment is required for the compartment material. Prior art is only suitable for home and ambient temperature environments. My invention can be customized to meet the needs of the end user as well as the cost the end user wants to incur for a material management system. Prior art is fixed in size and capability and thus self-limiting in terms of expansion to meet market demands and varying costs the end user wants to incur.

### SUMMARY OF THE INVENTION

A distributed system for the control and monitoring of containers and their associated contents as well as events unrelated to said containers and contents. Said system being constructed of a physical subsystem, an electrical/electronic subsystem and software networked together to form a distributed system. Each physical, electrical/electronic and software subsystem is configured into a containment system for the controlling/monitoring of material placed within containers and any related activities of such containers and associated material as well as activities independent of any container and/or its contents.

The configuration of a containment system may be a single unit with local and/or remote control or a networked system consisting of multiple container systems linked together with networking technology. When used in a distributed system each framework is given a unique value set by the user to serve as identification. A framework can be covered with a locking cover to prevent unauthorized access. The invention can be used in multiple applications due to the generic way the hardware and software has been designed. Containers are monitored for the presence/absence of material using a variety of electronic sensors or manual intervention. Material management is controlled by a real time clock and a message system which the user programs into the device. Each container can be configured with a time of day value, a message, user identification such as a password and material type identification. When the programmed time of day of a container is detected the message for the container is displayed either locally on a display device or remotely on a remote computing system allowing the user to take appropriate action. In the case of complex material handling, messages may direct the user to add material to the container, mix the container material with other container material, and stir the material or any message necessary to direct the user to take appropriate action related to the material. Programming and monitoring of containers and their associated material may be done locally in a standalone system or remotely in the case of a distributed system. Programming and monitoring of events unrelated to a container and its contents is also possible giving the system the flexibility to serve as a reminder system for any event the user wishes.

In conclusion the present invention provides for the following advantages:
1) An integrated system of electronics, software, physical containment and messaging to form a distributed system for material management.
2) A scalable system in terms of hardware, software and cost to service multiple markets and end user requirements.
3) The ability to expand to an unlimited number of containers.
4) A distributed system of container frameworks controlled through networking technology.
5) Suitable for the use in laboratory environments, home and office environments and medical clinics.
6) Use of a database system to allow for recording of container activity, user operations, user personal data, material types of containers and network activity.
7) A logging system to track and log user activities relating to adding, removing material from compartments, settings of alerts for compartments.
8) Intelligent material handling containers that have associated time of day values, messages, electronic sensors and alarms.

### BRIEF DESCRIPTION OF THE SEVERAL VIEWS OF THE DRAWINGS

FIG. 1A shows the front view of a MASTER FRAMEWORK showing the features of this framework.

FIG. 1B shows the rear view of a MASTER FRAMEWORK showing the connector panel.

FIG. 2A shows the front view of a SLAVE FRAMEWORK showing the features of this framework.

FIG. 2B shows the rear view of a SLAVE FRAMEWORK showing the connector panel.

FIG. 3A shows the left side interior view of a MASTER FRAMEWORK and the components.

FIG. 3B shows the left side interior view of a SLAVE FRAMEWORK and the components.

FIG. 3C shows the left side interior view of a MASTER FRAMEWORK using pseudo-containers.

FIG. 3D shows the left side interior view of a SLAVE FRAMEWORK using pseudo-containers.

FIG. 3E shows the left side interior view of an ADD ON FRAMEWORK and the components.

FIG. 4A shows the basic electronic blocks used in a MASTER FRAMEWORK.

FIG. 4B shows the basic electronic blocks used in a SLAVE FRAMEWORK.

FIG. 4C shows the basic blocks of an ADD ON FRAMEWORK.

FIG. 5A shows a top cutaway view of the most simple container type of a framework.

FIG. 5B shows an interior cutaway view of the most simple container type of a framework.

FIG. 6A shows a top cutaway view of container type FIG. 5 with the addition of an INPUT DEVICE (145).

FIG. 6B shows an interior cutaway view of container type FIG. 5 with the addition of an INPUT DEVICE (145).

FIG. 7A shows a top cutaway view of an enhancement to container type FIG. 6 in which sensor devices are embedded within the container walls.

FIG. 7B shows an interior cutaway view of an enhancement to container type FIG. 6 in which sensor devices are embedded within the container walls.

FIG. 8A shows a top cutaway view of an alternative to the container type FIG. 7 in which the sensor is placed on the bottom of the container.

FIG. 8B shows an interior cutaway view of an alternative to the container type FIG. 7 in which the sensor is placed on the bottom of the container.

FIG. 9A shows a top cutaway view of the most sophisticated container type in which all technologies of the previous containers are utilized.

FIG. 9B shows an interior cutaway view of the most sophisticated container type in which all technologies of the previous containers are utilized.

FIG. 10A shows a top cutaway view of the pseudo-container with sensor embedded within the framework.

FIG. 10B shows an interior cutaway view of the pseudo-container with sensor embedded within the framework.

FIG. 11 shows a configuration using a MASTER FRAMEWORK connected to an ADD ON FRAMEWORK to allow for the expansion of the number of containers for the system.

FIG. 12. Shows a configuration using a SLAVE FRAMEWORK connected to an ADD ON FRAMEWORK to allow for the expansion of the number of containers for the system.

FIGS. 13A, 13B and 13C show a networked system using a MASTER FRAMEWORK, FIG. 13A, electronically connected to other frameworks in this case a MASTER FRAMEWORK, FIG. 13B, functioning as a SLAVE and a SLAVE FRAMEWORK, FIG. 13C.

FIGS. 14A, 14B and 14C show a networked system in which a remote computing system, FIG. 14B, serves as the system controller for the frameworks. In this case, a SLAVE FRAMEWORK, FIG. 14A, and a MASTER FRAMEWORK, FIG. 14C, functioning as a SLAVE FRAMEWORK.

FIG. 15A shows a MASTER FRAMEWORK functioning in union with a remote computing system in which the remote system serves as both a monitoring as well as control system.

FIG. 15B shows a SLAVE FRAMEWORK functioning in union with a remote computing system in which case the remote system is both the does both control and monitoring of the SLAVE FRAMEWORK.

FIG. 16 shows the primary software module groups of the invention.

FIG. 17 shows the boot up process following a reset or power on.

FIG. 18 shows the process by which the system software discovers any frameworks attached in a networked based system.

FIG. 19 shows the interrupt service routine for handling interrupts from the real time clock.

FIG. 20 shows the interrupt service routine for handling interrupts from the microprocessor internal timer.

FIG. 21 shows the interrupt service routine for handling interrupts from a communications port or the control panel of a MASTER FRAMEWORK.

FIG. 22 shows the interrupt service routine for handling a power fail condition.

FIG. 23 shows the scheduler for running the software functions of the system.

FIG. 24 shows the logic for servicing interrupts from the real time clock interrupt service routine illustrated in FIG. 19.

FIG. 25 shows the software routine for handling the data input interrupts from the communications interrupt service routine illustrated in FIG. 21.

FIG. 26 shows the software routine for processing container activity.

FIG. 27 shows the software routine for handling data transfer with the communication ports.

### DETAILED DESCRIPTION OF THE INVENTION

To best explain the idea and use of the invention, a commonplace use will be described. This in no way should be construed as a limitation of the invention.

### EMBODIMENTS

There are four basic system configurations the invention can be customized to work within based on claims 5 and 6. Because the invention has been designed to be scalable and networked, the embodiment is dependent on the end user application. Though these are not the only combinations possible with the invention they represent common configurations for various end user environments. These embodiments are:

1000: standalone system

2000: remote control/monitor system

3000: networked system with standalone control

4000: networked system with remote control

In keeping with a scalable design, there are two steps in building a material management system using this invention. First is the identification of components for constructing a framework of containers. Second is the networking of said frameworks to form more complex material management systems. Said framework consisting of: (1) a plurality of container types (2) optional internal electronics (3) an optional data input and display system (4) a back panel for connectivity (5) various markings on the framework surface for container identification. Frameworks are networked together to form more complex systems in keeping with claim 6.

Frameworks are built from the subsystem components of claim 1 and networked systems are built from these frameworks.

### Framework Components:

1. The physical subsystem of claim 1 consisting of the following components:
   100: a framework consisting of a plurality of compartments of various diameters, shapes and depths embedded within the framework. Said framework being constructed of plastic or metal and suitable for exposure to limited heat, cooling and chemicals such as found in medical labs and biological labs. Said framework has internal electronics and software as well as a display and data input system to input and output information to program the device as well as receive messages and alerts from the system. Said framework can also connect to a remote computing system which can be program as well as monitor the framework. Said frameworks may be connected together to form a distributed system using networking technologies. Three types of frameworks are provided for within the invention when used in a standalone configuration:
      100a: A master framework with controlling electronics and software plus a display and input system and connectivity to other electronic systems and frameworks and 0 or more container types embedded within the surface of the framework;
      100b: A framework with controlling electronics and software but lacking a display and input system and requiring an external computing system or master framework 100a for control/monitor services and having the ability to connect to other electronic systems and/or frameworks and having from 1 to n container types;
      100c: An add on framework without internal electronics, software or a display or input system but having from 1 to n container types embedded within the surface and being used to expand the number of containers of a master framework 100a or slave framework 100b by physically connecting the internal wiring harness of the add on framework to the internal electronics of the master framework 100a or slave framework 100b.
   105: Six types of containers are available that are designed into the frameworks of 100a-c:
      105a: a container with an output device;
      105b: the container of 105a plus an input device.
      105c: the container of 105a with sensors embedded with the container walls;
      105d: the container of 105a with a sensor embedded within the bottom on the containers;
      105e: a container with all the functionality of containers 105a, 105b, 105c and 105d combined;
      105f: a pseudo-container that has a sensor device embedded with the framework surface and markings indicating presence of the sensor;
   106: an identification marking located in close proximity to each container;
   110: an enclosing cover for the framework 100a-c with a locking mechanism and an electronic notification device for detecting when the cover is open or closed;
   115: a back panel for the framework to provide connections:
      115a: power connection, fuse, power switch, reset switch;
      115b: communication ports;
      115c: power level and other notification devices;
      115d: an identification switch for the framework;
2. The electronic subsystem of claim 1 consisting of the following electronic hardware components housed within and/or associated with the physical system of claim 2:
   120: electronic printed circuit boards and components housed inside the framework to consist of;
      120a: microprocessor;
      120b: internal wiring harnesses for components;
      120c: connectors for wiring harnesses;
      120d: electronic components to support the framework and container functions;
      120e: connectivity to the back panel connectors for power, communications, indicators, etc.
   125: a data input unit (control panel) consisting of but not limited to:
      125a: keyboard or keypad
      125b: switches
      125c: magnetic card reader
      125d: bar code reader
      125e: wired or wireless input from a remote computing system
   130: a display unit consisting of but not limited to:
      130f: LCD display
      130g: LED display
      130h: graphics display
      130k: electronic voice system
   135: a power system from either an external source or an internal battery source which may or may not be rechargeable plus necessary power accessories such as fuse(s), on/off switches, reset buttons, power level indicators, over voltage protectors, etc.
   140: optional electronic sensors embedded in the containers 105c-f for detecting matter within the container. Said sensors to consist of but not limited to:
      140a: optical sensors
      140b: magnetic sensors
      140c: proximity sensors
      140d: pressure sensors
   145: an optional container input device located in close proximity to each container to input information. Said input device to be one of but not limited to:
      145a: push button switch
      145b: toggle switch
      145c: DIP or rotary switch
      145d: sensory input device
   150: an optional container output devices located in close proximity to each container to output information. Said output device to be one of but not limited to:
      150a: illumination device
      150b: audible device
   155: an optional temperature sensing device(s) embedded within 0 or more containers and/or within the framework;
   160: an electronic clock module for keeping time and day information;
   165: a device for nonvolatile storage of data to consist of but not limited to:
      165a: magnetic disc
      165b: solid state memory
   170: a switch or other input device to allow setting of an identification code for the framework;
   175: output devices to indicate the status of the system to include but not limited to:
      175a: power levels of the system
      175b: temperature levels of frameworks and containers
      175c: failed frameworks
      175d: failed containers
      175e: failed sensors
      175f: memory problems
      175g: loss of communication with networked components
   180: a remote computing system such as a personal computer or custom designed computing system which uses either wired or wireless technology to communicate to frameworks 100a and 100b;
   185: electronic communication technologies whereby frameworks can communicate through either a wired or wireless technologies to other frameworks and/or computing systems. Said communication device to be one of but not limited to:
      185a: an RS232 port
      185b: an Ethernet port
      185c: a USB port
      185d: an optical port
      185e: a custom RF (radio frequency) port
      185f: a Bluetooth port
      185g: a Wife port
      185h: a current loop port
      185i: an RS422 port
      185j: simple electrical signals
3. The software subsystem of claim 1. Said software being embedded within the electronics of the printed circuit boards in nonvolatile memory either as part of the microprocessor or stored within a separate memory device or as a separate program within a remote computing system 180 which communicates with the framework through wired or wireless technology. Said software being to control/monitor all functions of the system. Said software subsystem consisting of the following methods but not limited to:
   300: an operating system to control the system to consist of but not limited to:
      300a: a scheduler to schedule tasks of the system;
      300b: interrupt service routines to handle interrupts generated by hardware devices and/or software modules;
      300c: a boot up process to bring the system online;
      300d: a power management system to manage power failures and preserve system integrity during power failures and bring the system online when power resumes;
   305: a sensor method for processing signals from the container sensors as material passes through the sensor field 305a of the sensor. Said sensor field being a light path in the case of optical sensors; pressure in the case of a pressure sensor; a magnetic field detector in the case of a magnetic sensor.
   310: a method to send information to the framework display device 130 to consist of but not limited to:
      310a: system error messages
      310b: system warning (non-fatal) messages
      310c: system status messages
      310d: alarm/notification messages
      310e: messages related to the status of compartments
      310f: messages related to the status of a compartment framework;
      310g: messages related to programming the framework
      310h: database information
   315: a method to input information from a framework input device 125;
   320: a method to process input from a container input device 145;
   325: a method to output information to a container output device 150;
   330: a method for alerting a human operator to take action with respect to matter within a container 105 through messages. Said messages to consist of but not limited to:
      330a: mixing matter within a compartment
      330b: removing matter from a compartment
      330c: adding matter to a compartment
      330d: temperature of matter in a compartment
   335: a method for handling the electronic clock 160 to consist of but not limited to:
      335a: programming the time of day module;
      335b: processing a time signal from the module (148)
      335c: displaying the time and day information from the clock module;
   340: a communication method for sending information to a remote notification device such as a pager;
   345: a communication method for communicating between the frameworks 100a, 100b and a remote computing system 180 to include but not limited to:
      345a: a discovery process to determine what frameworks are attached to the network;
      345b: networking processes;
      345c: processes to communicate to a remote computing system;
   350: a method for data encryption of user data and other sensitive information;
   355: a method for logging information into nonvolatile storage devices 165;
   360: an electronic lock method for cover 110;
   365: a method to track the activities of the manually controlled containers of type 105a and 105 to consist of but not limited to:
      370a: tracking and logging when the input device 2.145 is activated;
      370b: counter for tracking the number of instances a container notification has gone unanswered;
      370c: untimely removal/addition of material from the container;
   370: a method to track and log the activities of the electronic sensors 140, 155, 110 of the containers 105c-f to consist of but not limited to:
      370a: sensor field activated when matter passes within range of the sensor field
      370b: sensor field deactivated when matter passes out of range of the sensor fields
      370c: counter for tracking and logging the number of instances matter is removed from the field proximate to the electronic sensors 106 of a container;
      370d: counter for tracking the number of instances matter is placed within the field proximate to the electronic sensors 106 of a container;
      370e: counter for tracking the number of instances a container notification has gone unanswered;
      370g: untimely removal/addition of material from the container;
   375: a method for the setting of the following features to configure a system to consist of but not limited to:
      375a: setting the real time clock
      375b: entering a name
      375c: entering a SSN
      375d: entering a patient ID value
      375e: entering patient medications
      375f: setting a primary administrator
      375g: setting multiple users without administrator privileges
      375h: setting multiple secondary administrators
      375i: assigning container(s) 105a-f to a patient/user
      375j: setting passwords
      375k: setting alarms based on the real time clock for containers and/or other events;
      375l: resetting all alarms
      375m: resetting all alarms, messages, power levels, etc. to default settings
      375n: clearing a patient/user database
      375o: clearing all the databases in the system
      375p: setting a message for container to display at alarm time
      375q: setting non-container based messages
      375r: specific material type such as a prescription drugs, chemicals, biological matter which is to be contained within the containers 105a-f,
      375s: setting the environment of the system: refrigerated or elevated temperature
      375t: view all alarms set;
      375u: view all patients/users;
      375v: view all patients/users records in their database;
      375w: view activity of a container;
      375 xs: set the back light level of the LCD;
      375y: set the volume level of the audio device;
      375z: set the remote alarm communication port type;
      375aa: set the remote control/monitor communication port type;
      375ab: enable/disable the remote control/monitor system;
      375ac: enable/disable the remote alarm system;
      375ad: view all the material type in the general database;
      375ae remove contents of a container before its designated alarm time;
      375af: open/close the electronic lock if an electronic locking system is used;
      375gh: setting the framework number of the container framework;
      375gh: enable/disable a container's sensor device;
      375ai: enable/disable a container's input device;
      375aj: enable/disable a container's output device;
      375ak: alarm/notification messages associated with a container 105a-f;
      375al: user/patient information;
      375are: messages independent of a container 105a-f or a container framework 100;
      375an: complex messages for container material handling instructions;
      375ao: messages for system status in addition to default status messages;
   380: a discovery method to determine the type of framework 100a-c, number and type of containers 105a-f and network topology;
   385: a method to download software into the non-volatile memory of from a remote computing system.

### Basic Functionality of the Embodiments

All embodiments have the same generic functionality either in a standalone configuration or networked configuration. Functionality can be customized for the end user application through the configuration features described in section 3.375 of the EMBODIMENTS, the types of containers 105a-f designed into the frameworks 100a-c, the messaging system of section 3.360 of the EMBODIMENTS, the types of user actions described in section 3.330 of the EMBODIMENTS, the setting of administrator levels, passwords and data encryption described in sections 3.375 and 3.350 of the EMBODIMENTS.

At power on time or when a reset is issued, the system software determines the system configuration according to section 3.345 EMBODIMENTS. In other words, the system software will determine the type of framework, number and type of containers and the network topology (i.e. what other frameworks and remote computing devices it is attached to) each time there is a power cycle or a software reset thus preventing the user from having to program the system configuration into the system. This is in keeping with claim 5 for a distributed system.

After power on, the sensors 2.140 embedded within the containers 1.105a-f create a sensor field either of light waves, pressure, magnetic or capacitive type which is interrupted when material is placed within or removed from a container. Internal electronics 2.120 detect this interruption and register it through the method 3.305. Method 3.305 functions with the aid of the microprocessor timer. This timer is programmed to generate an interrupt at a minimum of every 50 ms. During this interrupt period the software reads the sensors of all the containers and logs the state of the sensor as being ON or OFF. An ON condition means that material is in the container and an OFF condition means the container is empty. The ON and OFF states are generated through the sensor electronics which are integrated into the electronics of the printed circuit board 120 which allow the microprocessor to exam the sensor state. In the case of container types 105a and 105b which do not have embedded sensors, the user responds through either the input device 145 or the control panel 125. When material is placed within a container the user must acknowledge through the input device 145 or 125 and when material is removed the user must respond in a similar manner. Regardless of the manner of interrogating the state of the container, the state is logged into nonvolatile memory with the time of day which is read from the real time clock circuitry 160. In this manner, all activities of the containers can be retrieved at a later date allowing the user to know when material was placed into a container, when material was removed or if material was added or removed at the proper time.

After power on, the operator places material within the desired containers 1.105a-f and programs the containers according to section 3.375 of the EMBODIMENTS. The operator is responsible only for programming only the menu items listed in section 3.375 of the EMBODIMENTS. Not all these menu items need be used but a sub-set is required for minimal operation. This sub-set being the (a) setting of the real time clock 3.375a for the proper time of day (b) setting an alarm for the containers 3.375k (c) setting a message 3.375p for display at alarm time for each container. The operator may log the type of material within each container according to section 3.375r of the EMBODIMENTS.

When the alarm for a container is triggered the programmed message 3.375p is displayed on the display unit 2.130 and the output device 2.150 of the container is activated. The operator takes the appropriate action according to the message 3.375p displayed on the display unit 2.130. At the moment the material is removed from the container 1.105a-f, the electronics detects the movement of the material through the sensor field 305a, the microprocessor timer is constantly examining the ON or OFF condition of each container every 50 ms and reads the sensor field 305a and logs the change into the database 3.355 and resets the alarm for the container and stops the container output device 2.150. If an alarm is not responded to by the operator within a time period, a no response is also logged into the database allowing a person monitoring the device to know if alarms are being ignored. A no response condition can be known by the software since at interrogation time every 50 ms the software checks a table of alarms to determine what container should be serviced at what time. If the software does not detect a change in the sensor field at alarm time it is obvious the user failed to take action. In the situation where the unit is used for prescription medication, an RN or LVN or veterinarian can review the database log for proper administering of medications at the proper times. If container types 105a or 105b are being used, there is no electronic sensor to detect movement. In the case of container type 105a, the operator will manually respond to the alarm through the control panel 2.125 to reset the alarm. In the case of container type 105b, the user may use the input device 2.145 of the container having the alarm or the input device 2.125 on the control panel to reset the alarm. In the case of a manual response to an alarm, the system software will log the response into the database. The database will allow a running log of all activity 3.370 related to a container to be maintained in the nonvolatile memory 2.165. Such a log of activity is necessary when the device is being used for handling prescription medication administration and thus frees an LVN or RN from having to maintain a hand written log. Since the log is kept within nonvolatile memory 2.165 it is preserved through power cycles and can be recalled at a later date through method 3.345 in the situation where the log will be printed out, or faxed or emailed or stored on hard disk. Log information may also be displayed on the framework display device 2.130 for review.

Method 3.375 allows for the system to keep a record of a multitude of settings for the invention. One primary feature is the building of an alarm table for all containers in the system. This table allows the software to know at what time each container requires servicing and to set off the appropriate alarm and display the proper message. The real time clock generates an interrupt every 60 seconds during which time the software will scan the alarm table for containers that require servicing as previously described. Should the user fail to respond to a service request, either by the software detecting that material has not been added or removed from the container or the user has not responded in the case of container types 105a and 105b, this is logged as previously described. However, should the user respond this is also logged as previously explained. Methods 3.365 and 3.370 list the actions that can be logged with respect to container activities.

In the manner previously described, a container becomes more than a holder of material. Rather it is connected into the electronics and software of the framework and becomes an intelligent material handling apparatus which has associated time of day values, messages, electronics sensors and a logging system.

### Preferred Embodiment

### 1000: Standalone System

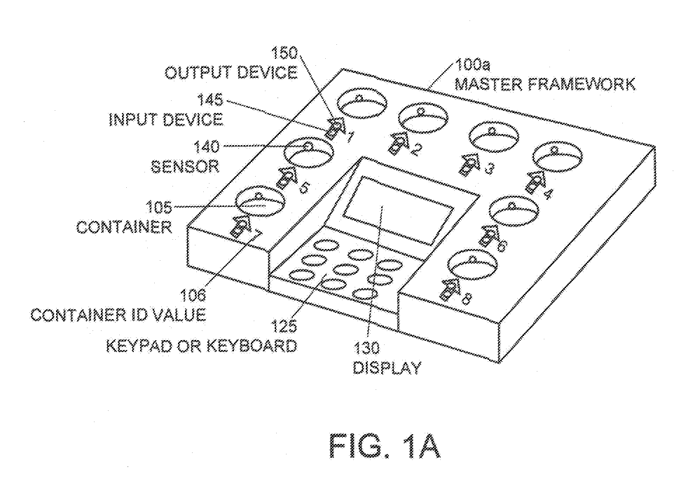

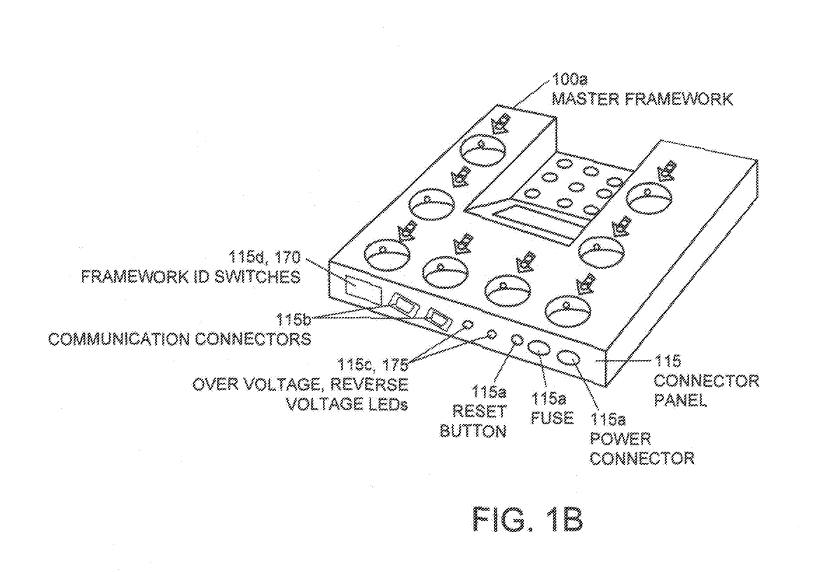

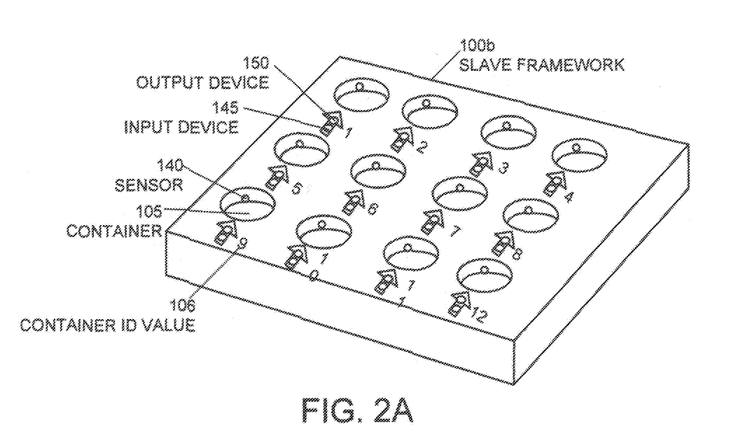

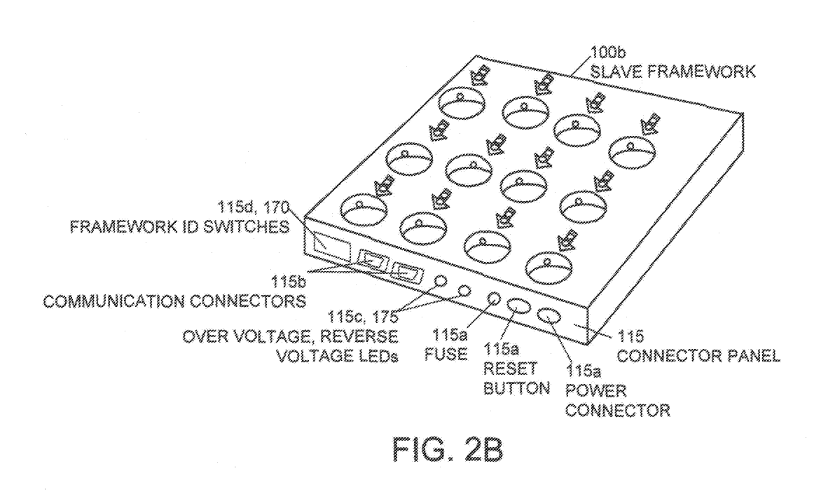

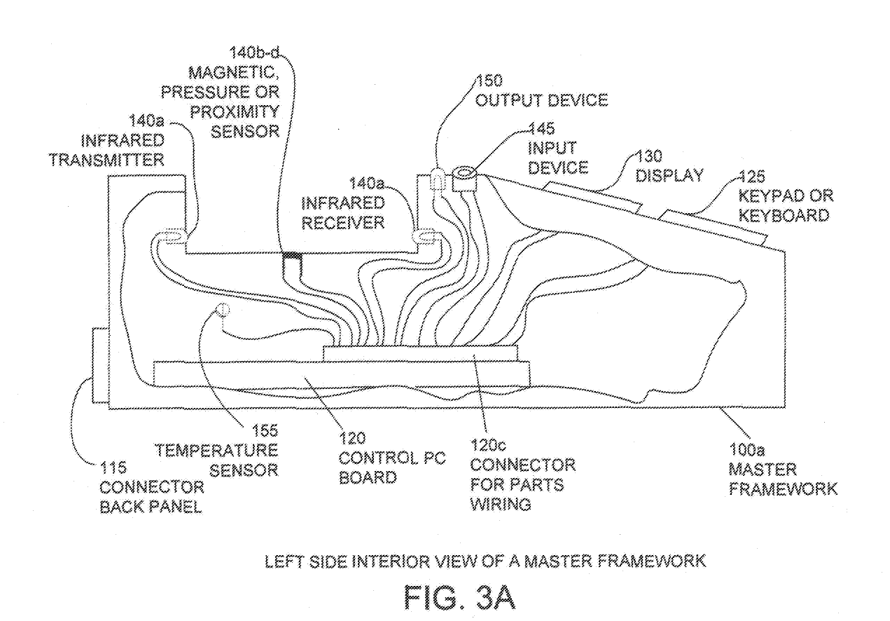

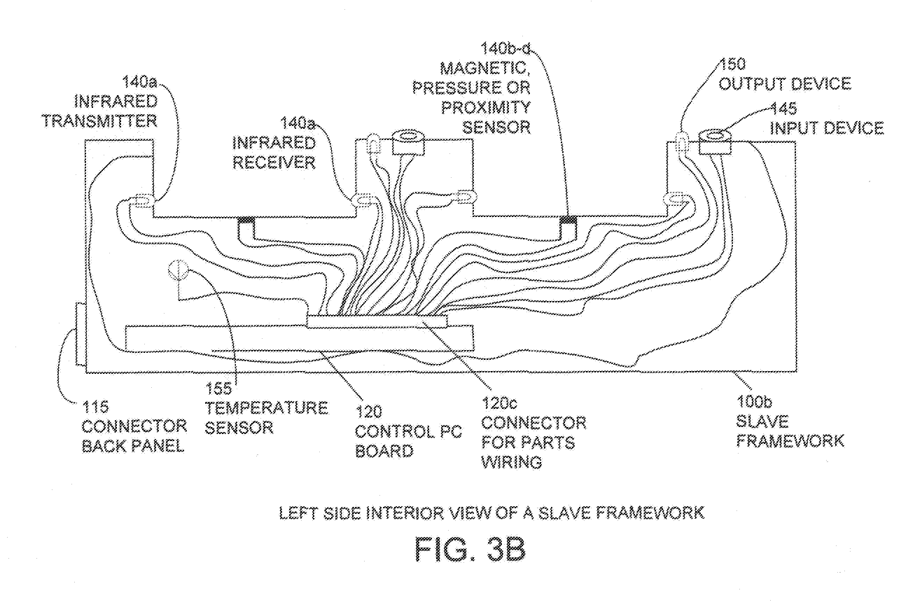

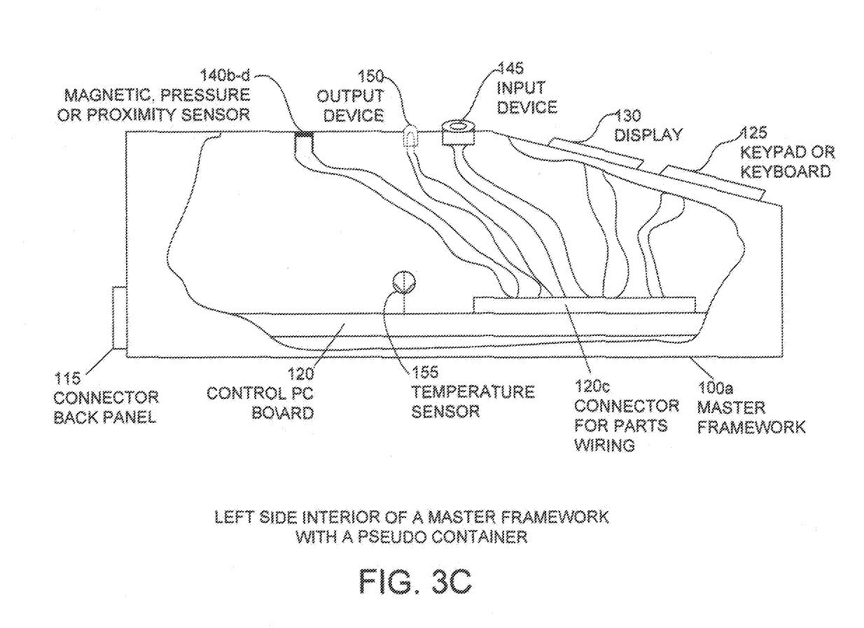

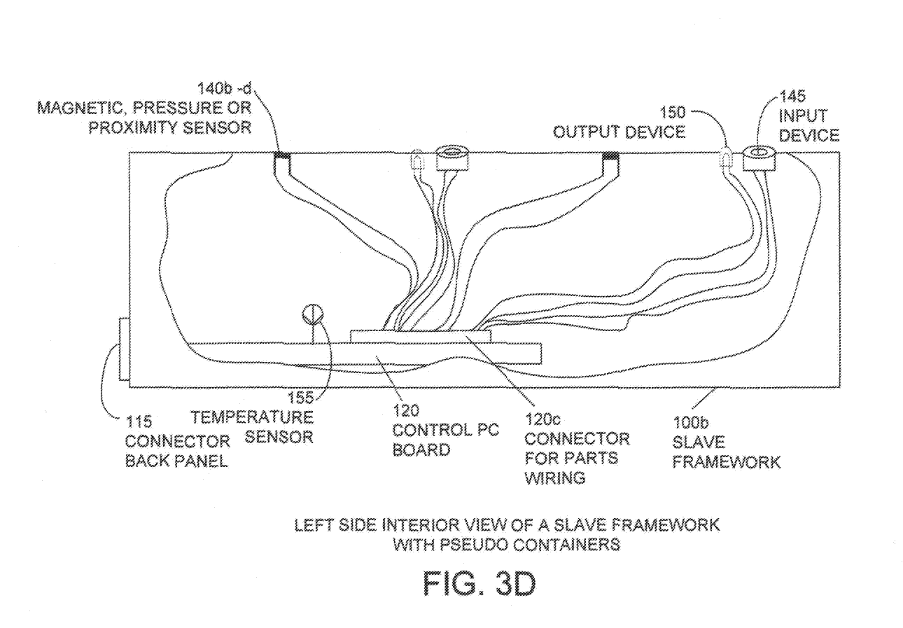

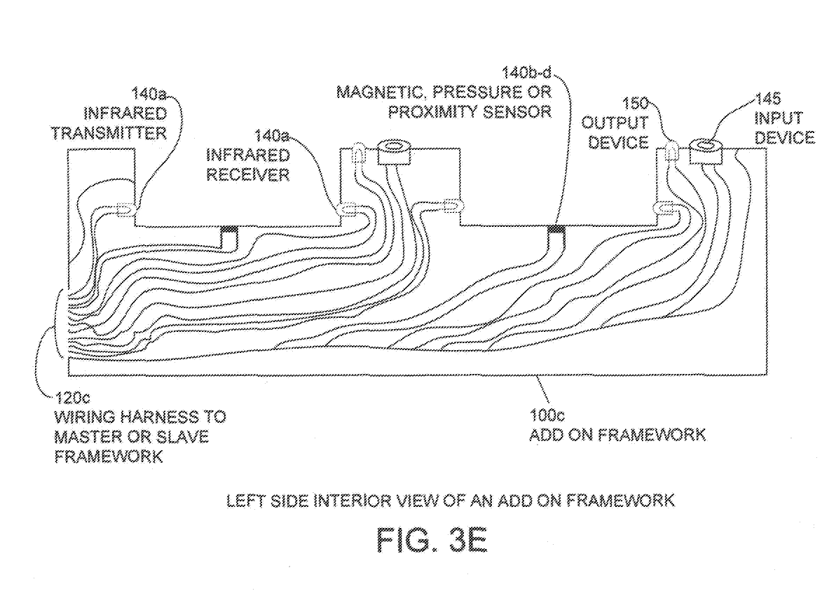

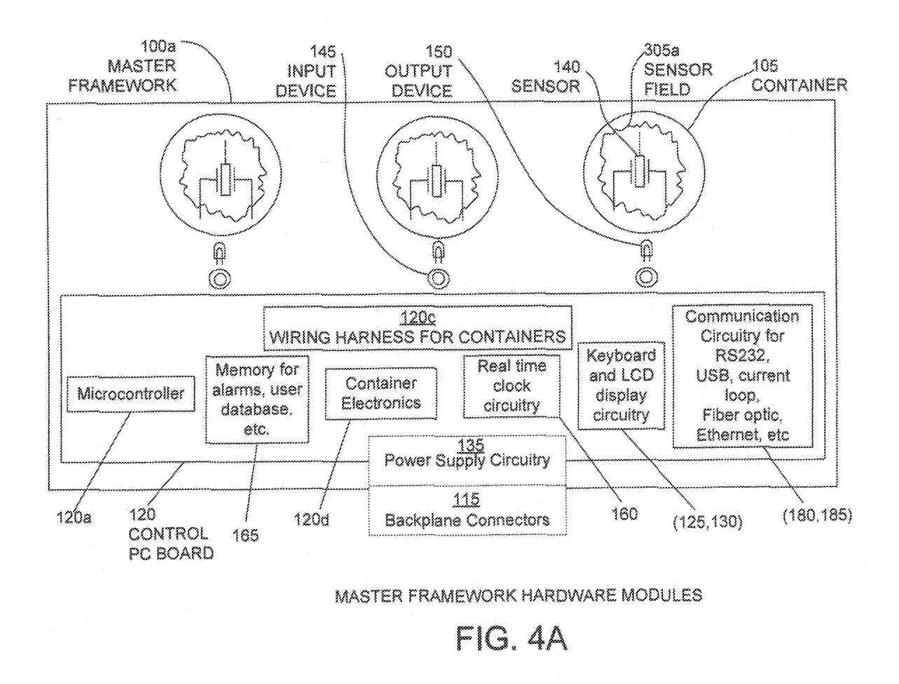

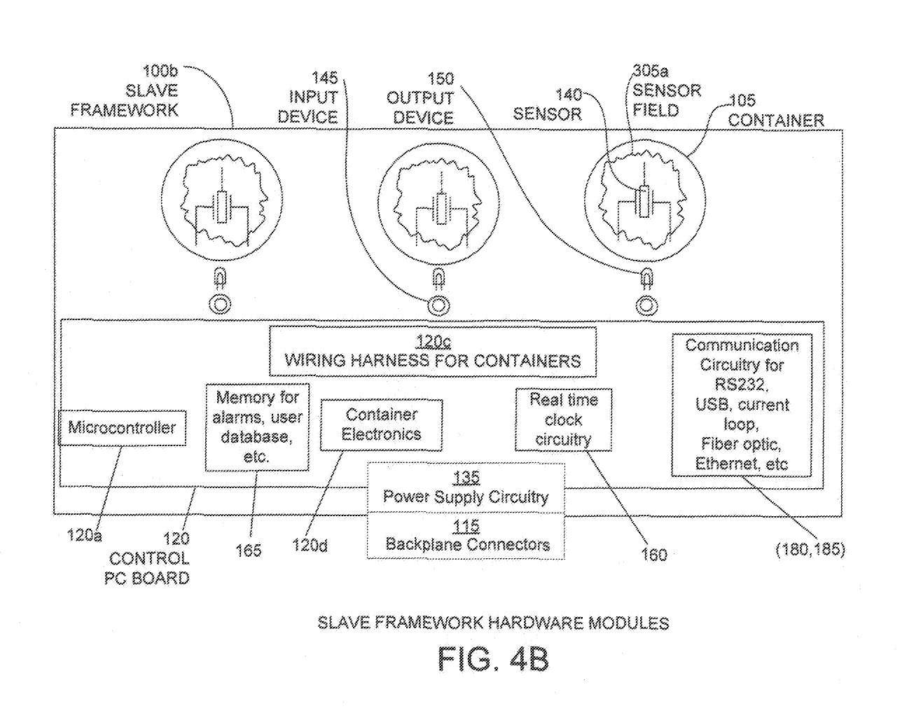

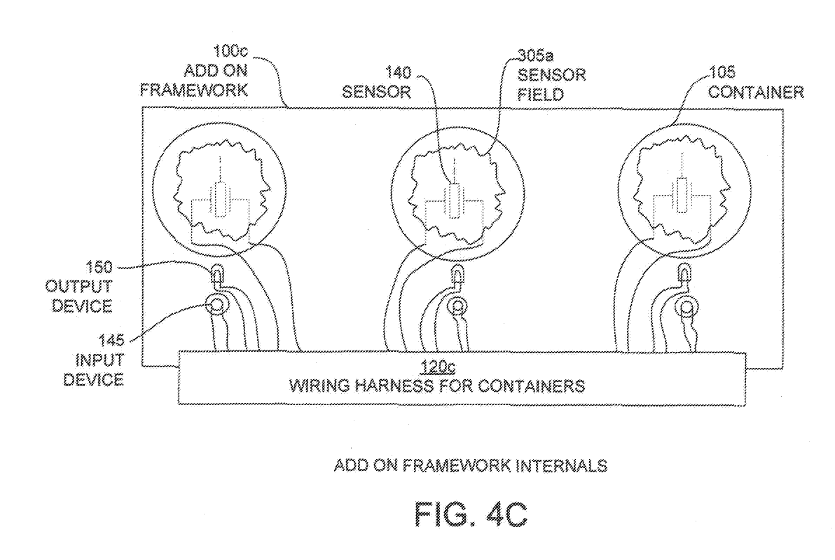

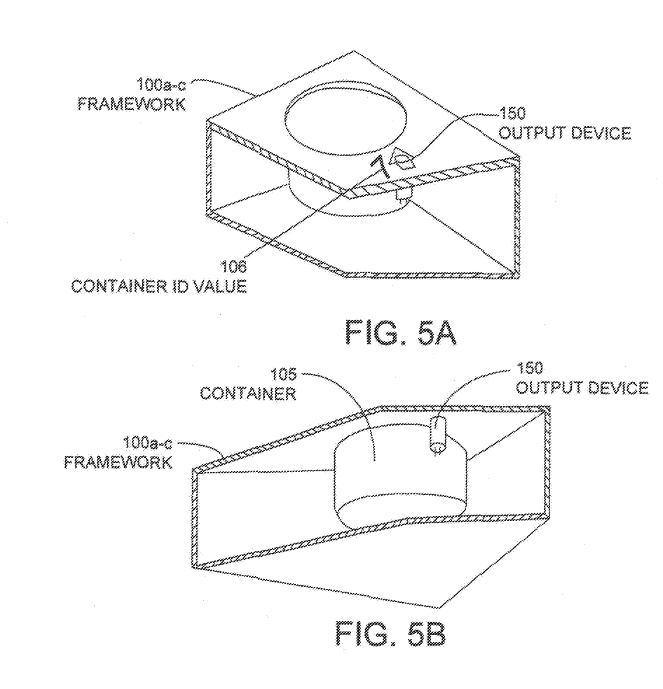

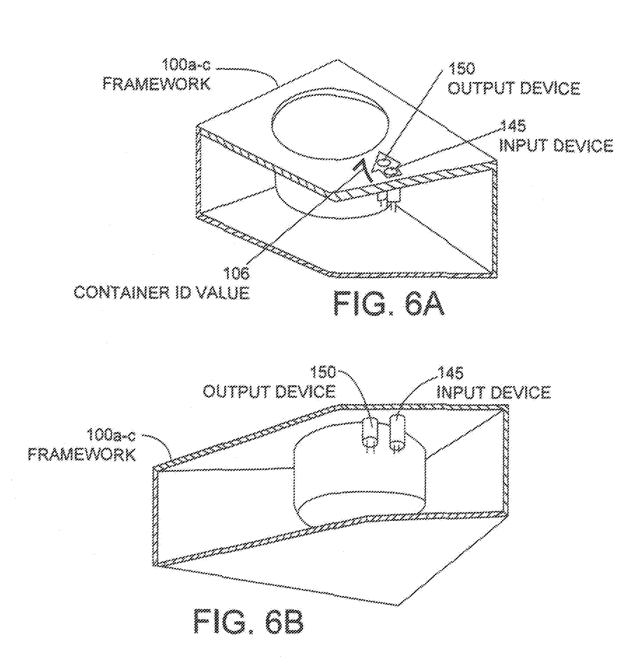

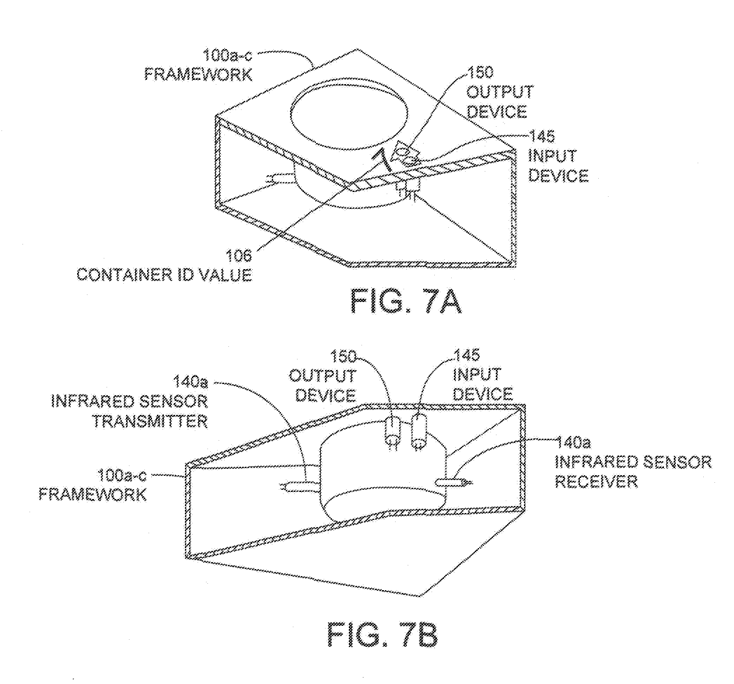

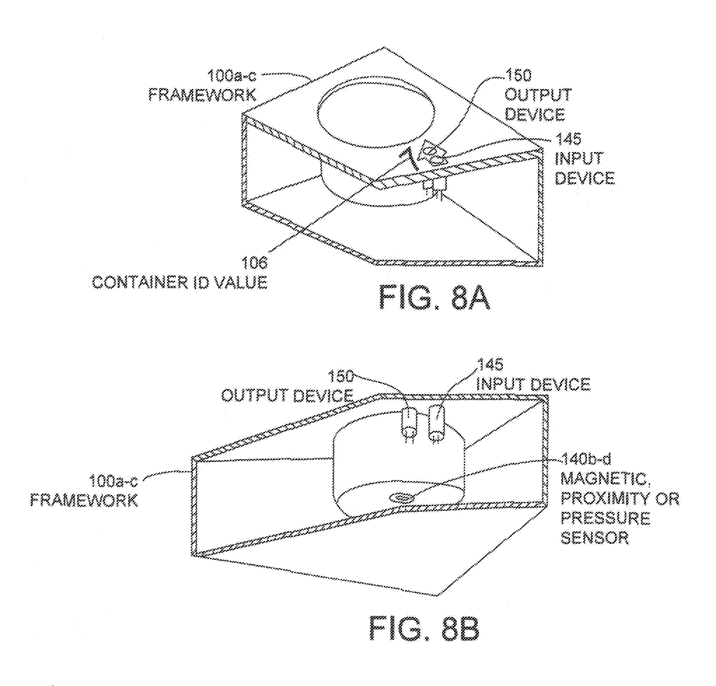

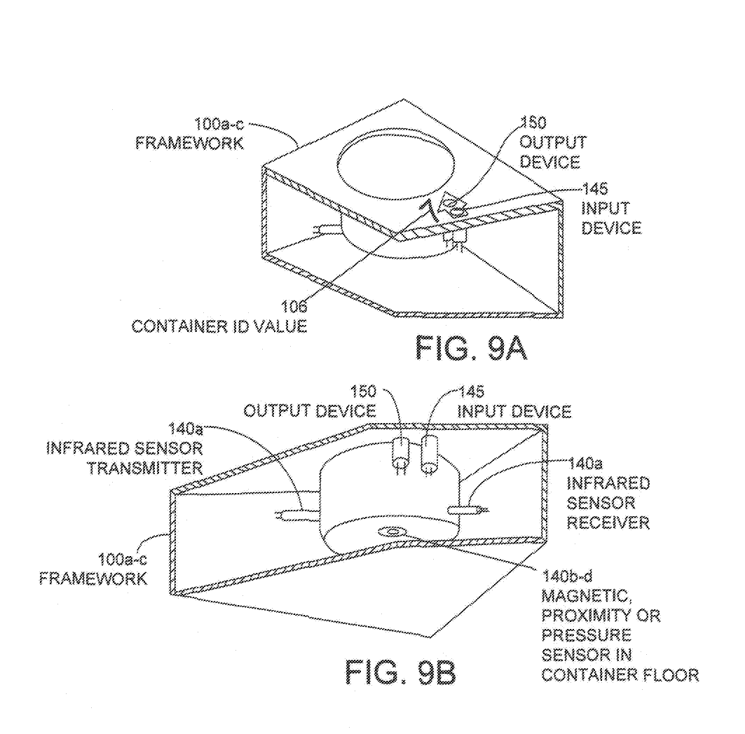

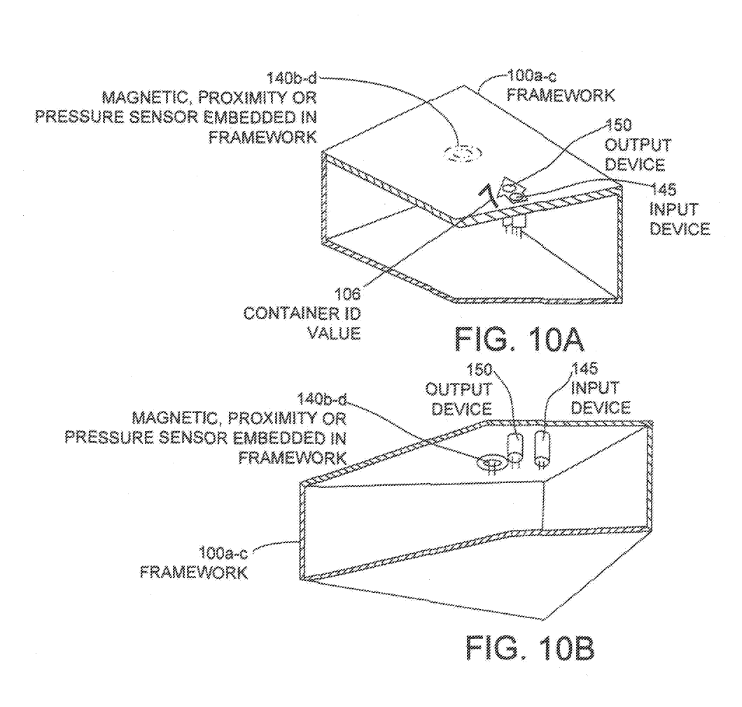

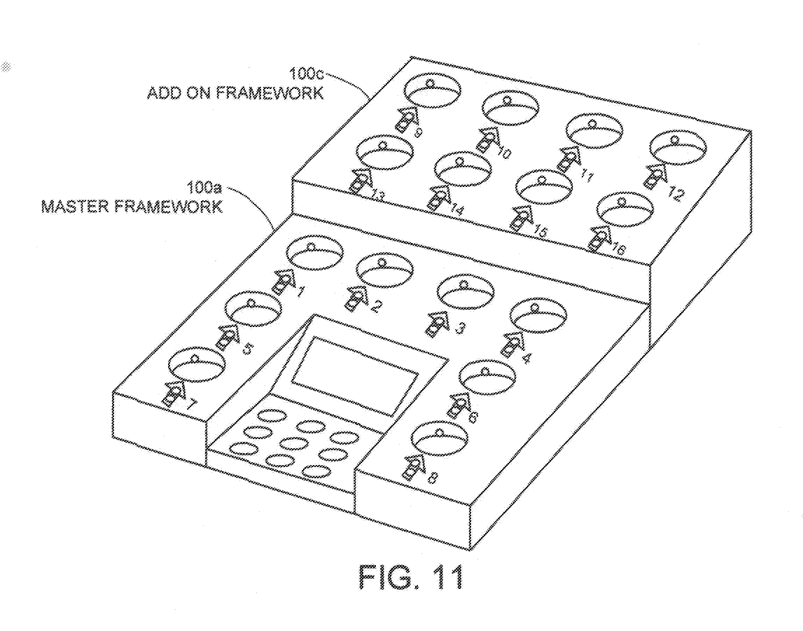

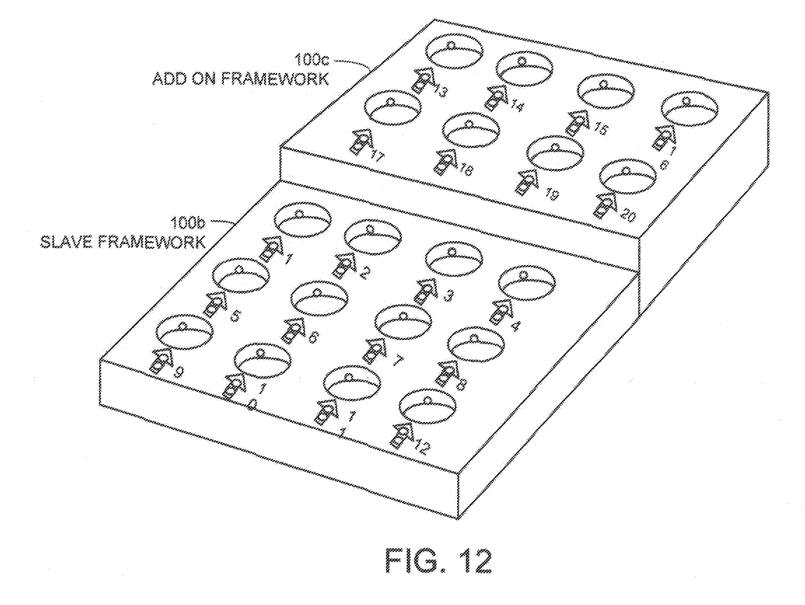

The standalone system embodiment is the primary starting point for constructing the other embodiments. All other embodiments are enhancements to the standalone system as is in keeping with claims 5 and 6 for a networked and scalable design. The construction of a preferred embodiment for a standalone system is seen in FIGS. 1A, 1B, 3A, 3C, 4A. The container type depending on the application and user preference. A standalone system consists of a master framework 1.100a with a plurality of container types (105a-f) and optional ads on framework 1.100c with a plurality of container type's 1.105a-f. A standalone system has all the electronics required to function as an independent unit. Functionality of a standalone system is the same as described in BASIC FUNCTIONALITY OF THE EMBODIMENTS.

For added security, the standalone system may have a locking cover 2.110 installed on the unit. In the case of the locking cover there is an electronic sensor which detects when the cover is opened and closed. This information is logged with a time stamp using the value from the real time clock. Said time stamp allows an administrator or user to track when access was made to the system. With a locking cover only authorized personnel can have access to the containers allowing for a level of security when the material of the containers is restricted.

### Alternative Embodiments

Alternative embodiments are the second step in building more complex material management systems. Alternative embodiments being networked systems of frameworks 1.100a-c and/or a remote computing system 180. Alternative embodiments support claims 5 and 6 of the invention as scalable and networked systems. All alternative embodiments build upon the features of the standalone system with the added capability of networking and remote computing.

There are three primary alternative embodiments:

2000: remote control system

3000: networked system with standalone control

4000: networked system with remote control

### 2000: Remote Control System

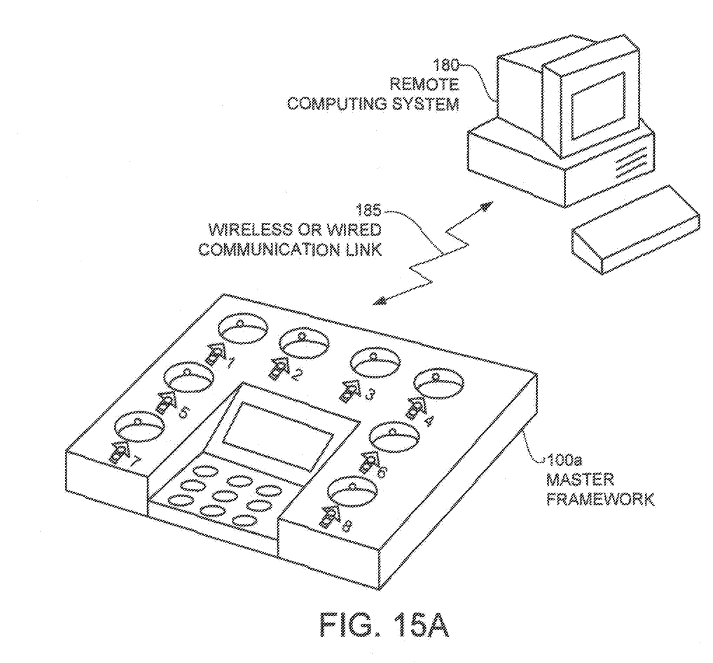

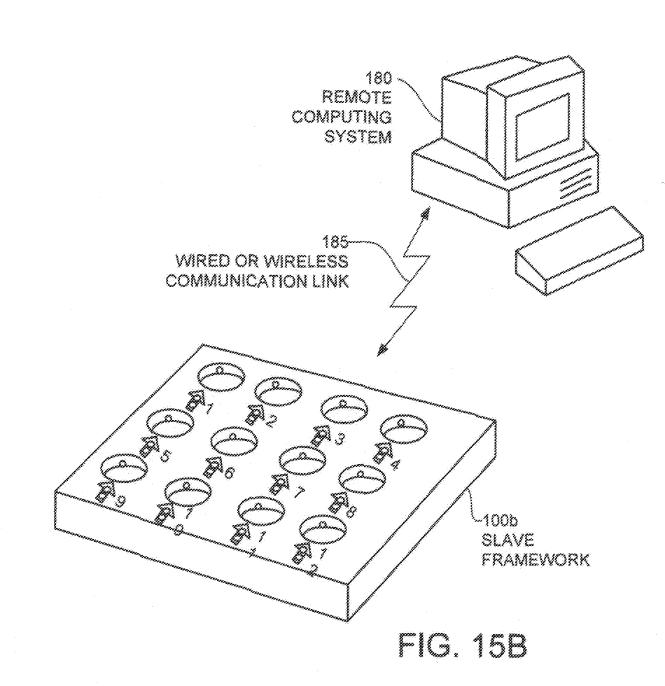

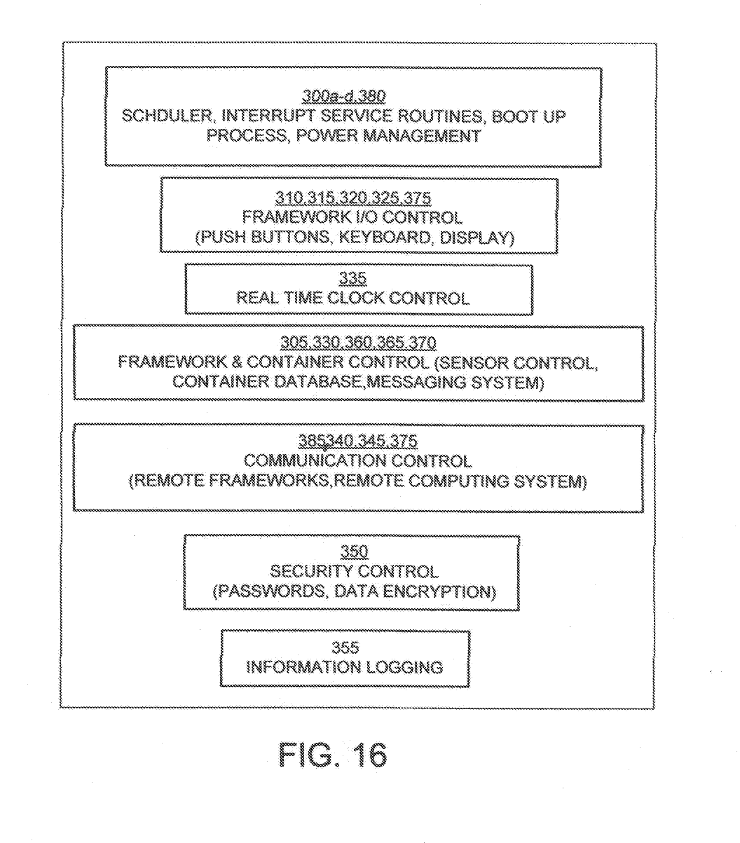

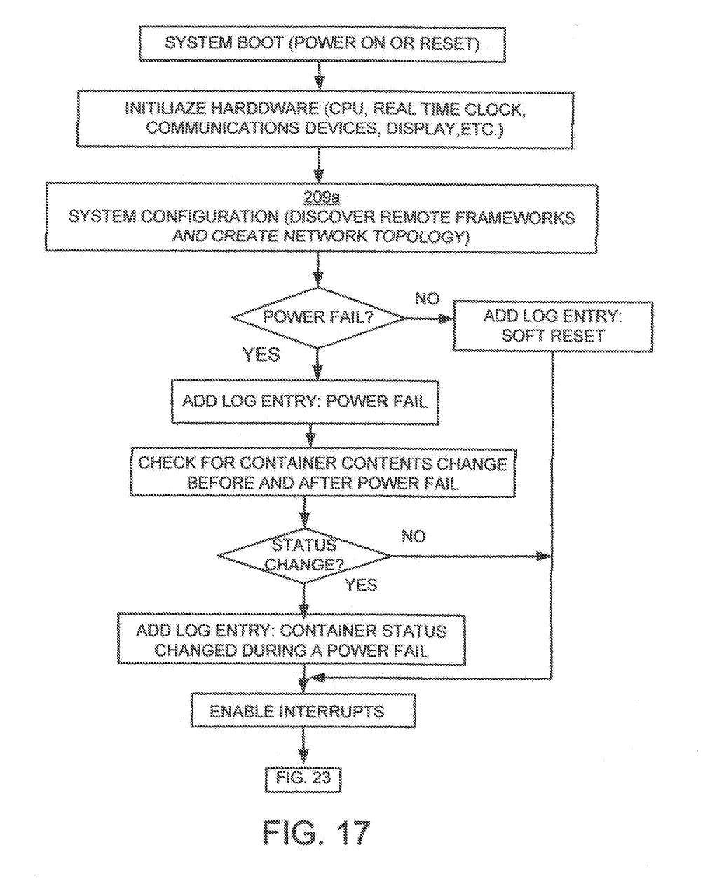

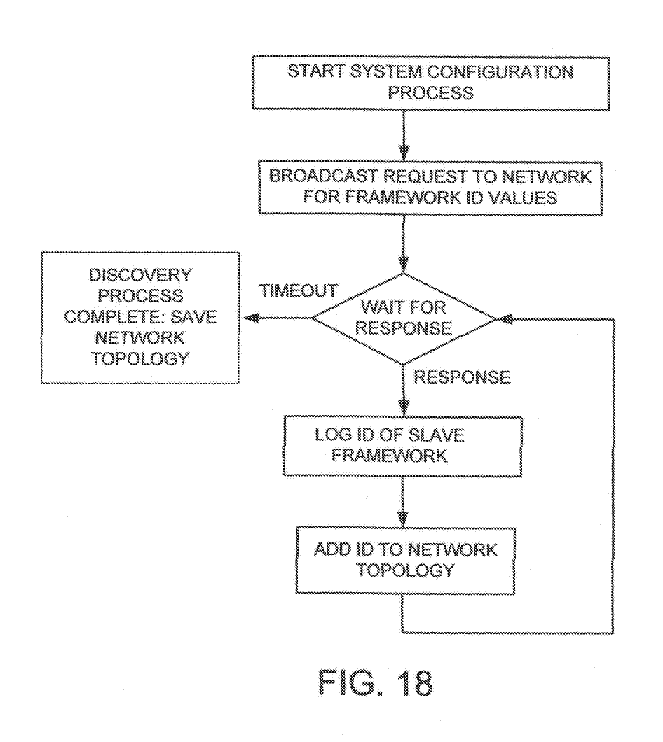

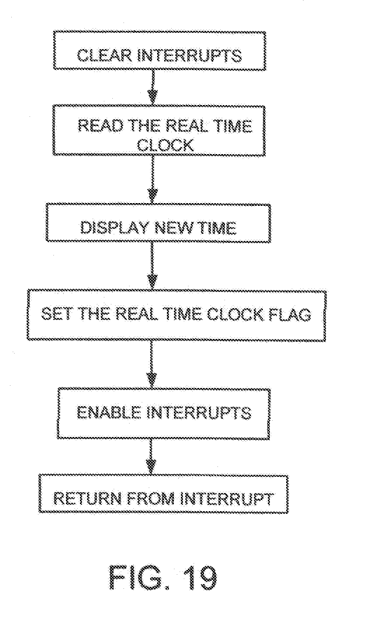

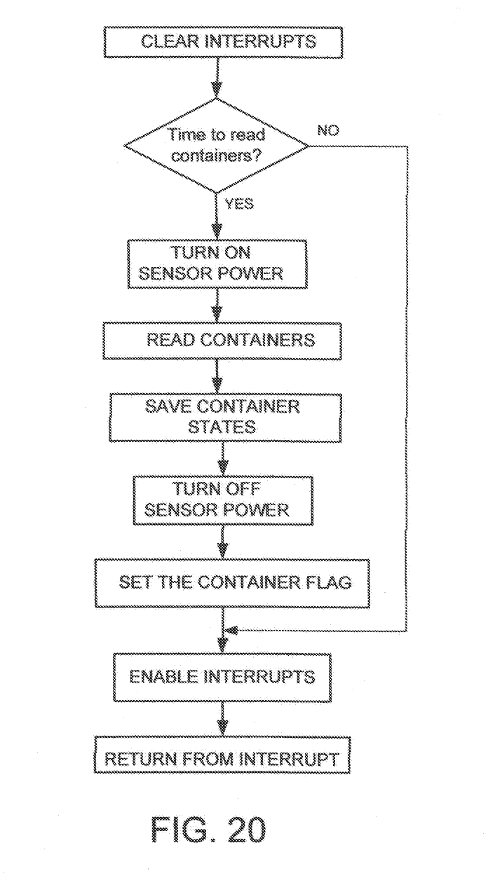

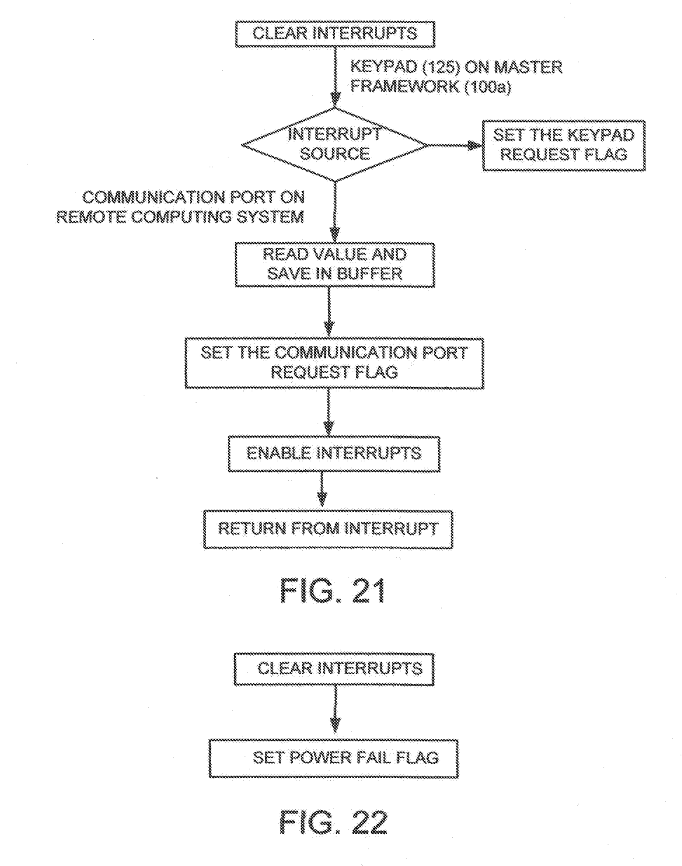

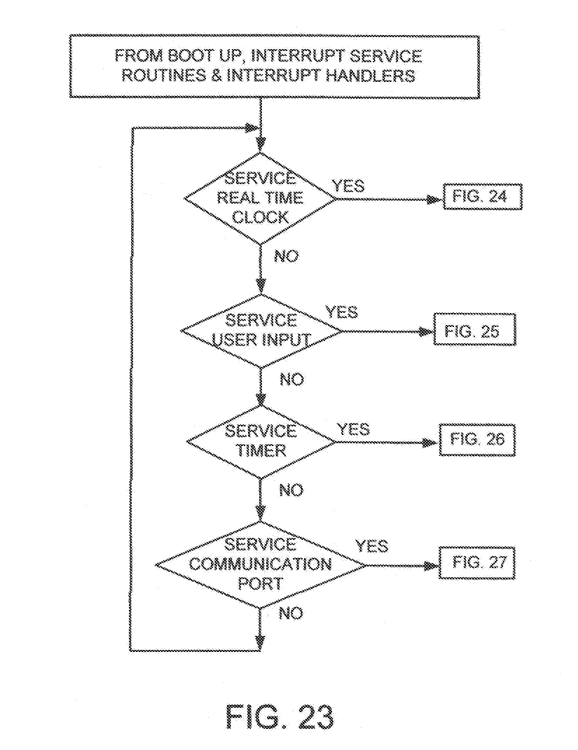

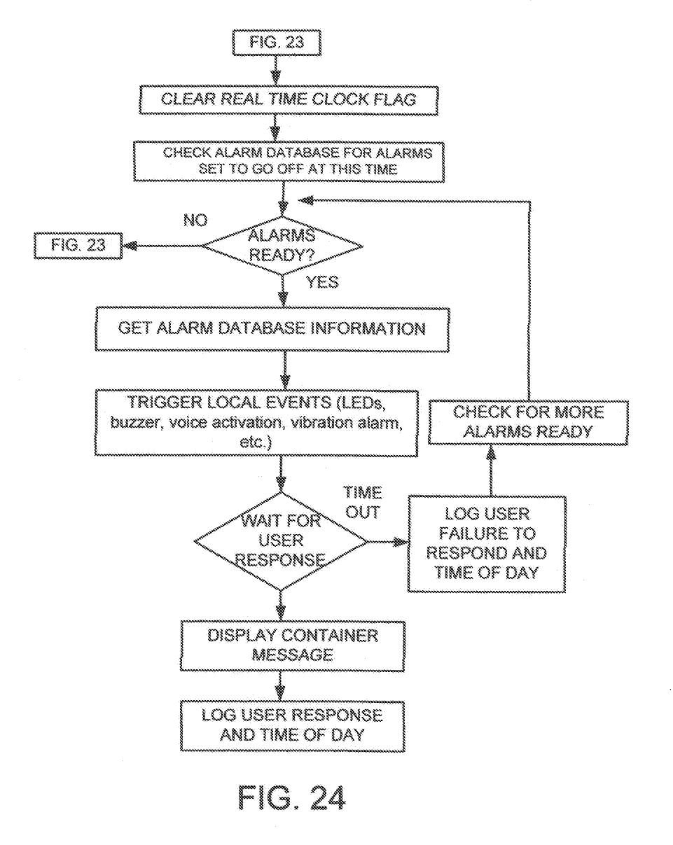

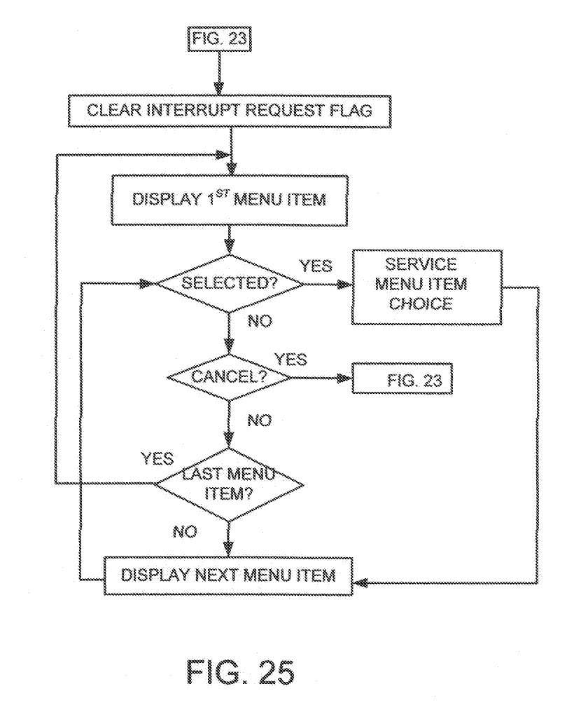

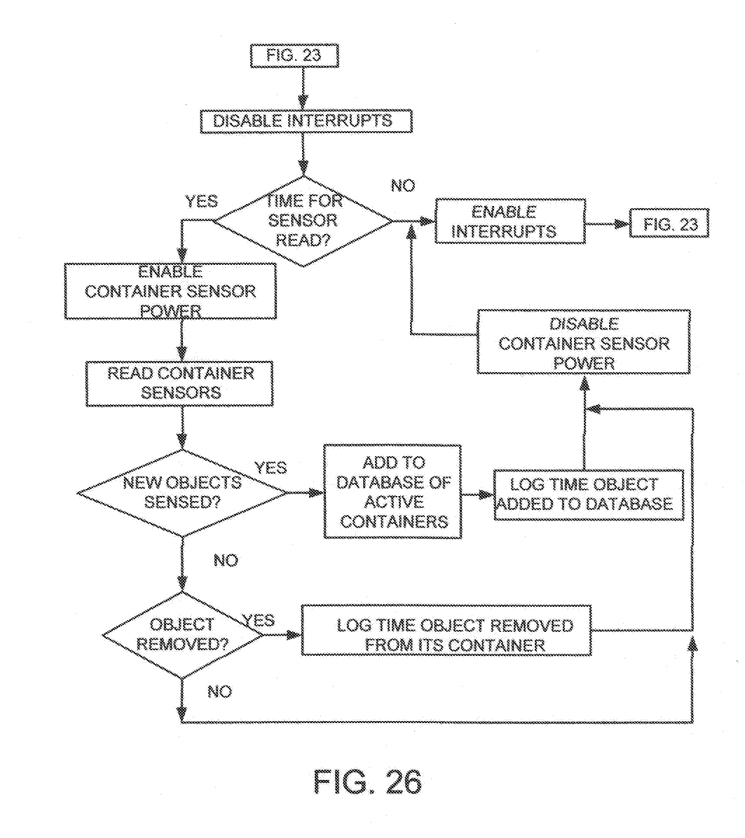

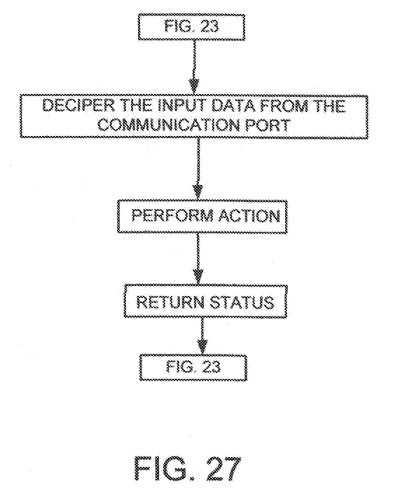

The remote control system is comprised of the standalone system 1000 with the addition of a remote processing system 2.180 and networking technologies 2.185. This embodiment has the added advantage of allowing a remote computing system the capability to monitor as well as control the master framework 1.100a thus allowing the framework to be located at a distance and still monitored or controlled. The remote control system is seen in FIG. 15A. FIG. 15A uses a master framework 1.100a connected to the remote computing system. In this configuration, either the remote computing system or the master framework can serve as the main control system or both can serve this function. In FIG. 15B a slave framework 1.100b is attached to the remote computing system. In this configuration the remote computing system must do the controlling and monitoring of the framework since a slave framework 1.100b is not equipped with an input and display system. The remote control system has all the functionality of the standalone system 1000 with the advantage of being able to be controlled/monitored from a distance. This embodiment is designed for a single master framework 1.100a or a single slave framework 1.100b to be remotely controlled and monitored when a standalone system is not convenient. More than a single framework 1.100a, b is not allowed in this embodiment. In the application of a chemical or biological laboratory application where the framework 1.100a, b is located behind a protective enclosure, the remote system allows for programming and monitoring of the framework container material from the safety of a remote position.

### 3000: Networked System with Standalone Control

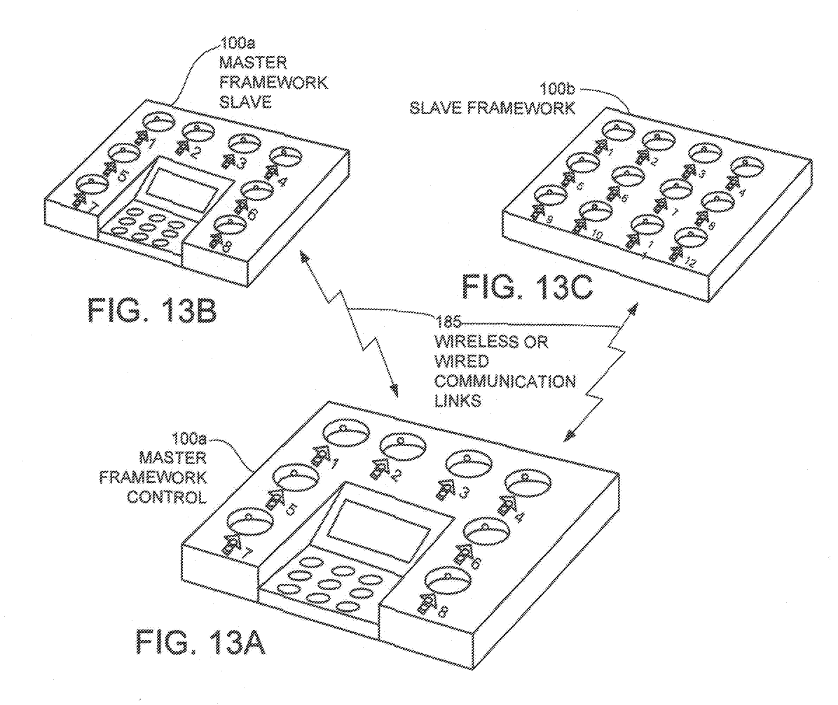

The networked system with standalone control is a combination of the standalone system 1000 with the added capability of networking technology 1.185. This system allows multiple frameworks 1.100a-c to be networked into a single system and controlled from a master framework 1.100a. This embodiment can be used in a small clinical environment where container frameworks 1.100a-c are located in patient's rooms and the master framework 1.100a allows an operator such as an LVN or RN to program and control the remote container frameworks. The embodiment for a networked system with standalone control is seen in FIG. 13. A master framework, FIG. 13B, has the capability to function as a slave framework if necessary allowing the end user to purchase all master frameworks and configure some as slaves and leave one as the control unit. This is in keeping with claim 6 in which the invention is scalable. A networked system with standalone control configuration is created by networking master and slave frameworks 1.100a, b together using networking technologies 1.185. The controlling master framework FIG. 13A receives alarm messages from the networked frameworks (FIG. 13B, FIG. 13C) to be displayed on the display unit of FIG. 13A notifying the operator of the time to manage the framework container material, such as dispensing a medication. Each framework 1.100a-c connected to the network has an identification value set by a switch 2.170 connected to the back panel 1.115 of the framework. This identification value is read by the controlling framework FIG. 13A during the discovery process 3.345a at power on time or during a soft reset allowing the system software to build a network topology map. When a remote framework, FIGS. 13B-C, require servicing such as during an alarm condition, the framework transmits its identification value along with its service message to the controlling framework FIG. 13A. The controlling framework, FIG. 13A, transmits messages back to the requesting framework using the identification values of the controller FIG. 13A and the requesting framework FIGS. 13B-C. In this manner, the operator knows which remote framework requires servicing. Furthermore, at the requesting framework, FIGS. 13B-C, the alarm for the container needing servicing has been activated allowing the operator, once reaching the site where the framework is located, to know the container requesting service. Once the operator has serviced the container, the alarm can be deactivated using the input device 2.145 should the framework have that type of container as part of its construction.

### 4000: Networked System with Remote Computing

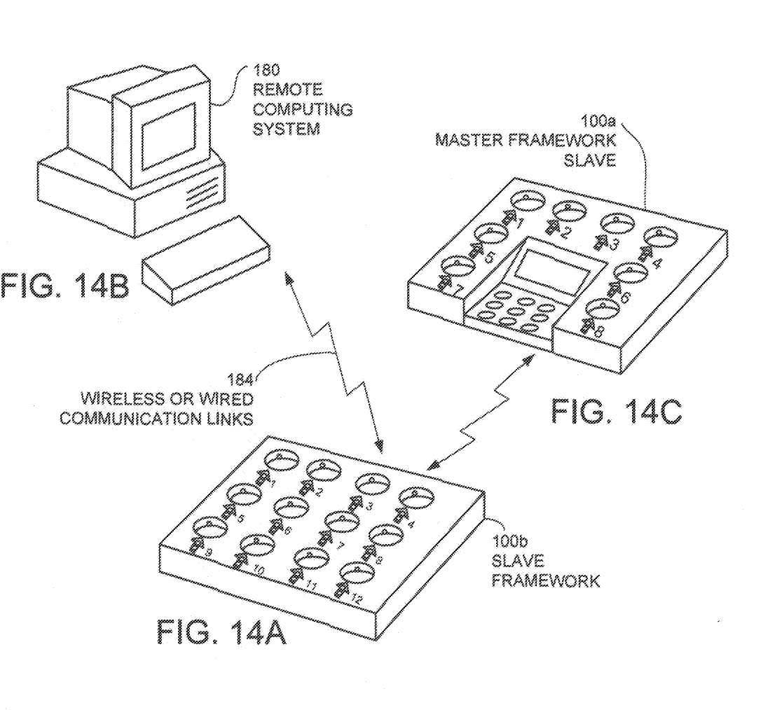

The networked system with remote computing uses a remote computing system 180 connected with networking technologies 1.185 to remote frameworks 1.100a-c. This system allows multiple frameworks 1.100a-c to be networked into a single system and controlled from a remote computing system. This embodiment can be used in large clinical environments where a container framework is located in patient's rooms and the remote computing system allows an operator such as an LVN or RN to program and monitor the remote container frameworks from a nursing station. This embodiment is seen in FIGS. 14A-C. The advantage of this embodiment over the networked system with standalone control 3000 is the remote computing system allows for more complex software required to monitor and control many frameworks as would be found in a large clinic, animal clinic or laboratory. Bearing in mind that a framework can have an unlimited number of containers with very complex material handling messages, a more complex user interface is required such as a graphical user interface with more complex controlling software since multiple framework containers can require servicing simultaneously. Whereas the networked system with standalone control 3000 does not have the processing power, memory or display for such a large network but rather is intended for small environments. This embodiment represents the upper end of complexity of the invention. Whereas the standalone system 1000 represents the most simple configuration of the invention.

Networking of frameworks for this embodiment is a similar process as in the networked system with standalone control 3000. A master framework FIG. 14B has the capability to function as a slave framework 1.100b if necessary allowing the end user to purchase all master frameworks 1.100a and configure some as slaves and leave one as the control unit. However, in a large environment, the user would probably purchase all slave frameworks and save the expense of the added electronics and software required for the control panel. The controlling remote computing system programs the connected frameworks and monitors all container activity. Each framework 1.100a-c connected to the network has an identification value set by a switch 2.170 connected to the back panel 1.115 of the framework. This identification value is read by the controlling remote computing system FIG. 14B during the discovery process 3.345a at power on time or during a soft reset allowing the system software to build a network topology map. When a remote framework, FIGS. 14A, C, requires servicing such as during an alarm condition, the framework transmits its identification value along with its service message to the controlling computing system. The computing system transmits messages back to the requesting framework using an assigned identification value of the computing system and the requesting framework FIGS. 14B, C. In this manner, the operator knows which remote framework requires servicing. Furthermore, at the requesting framework, FIGS. 14B, C, the alarm for the container needing servicing has been activated allowing the operator, once reaching the site where the framework is located, to know the container requesting service. Once the operator has serviced the container, the alarm can be deactivated using the input device 2.145 should the framework have that type of container as part of its construction.

What is claimed is:

1. A distributed system of electronically controlled and monitored containment systems for the management and handling of solid and liquid material comprised of the following subsystems:
(a) Physical subsystem
(b) electrical/electronic subsystem
(c) Software subsystem

2. The physical subsystem of claim 1 consisting of:
(a) a framework constructed of plastic or metal and suitable for exposure to limited heat, cooling and chemicals such as found in medical labs and biological labs and consisting of a plurality of containers of various diameters, shapes and depths embedded within the framework surface or designated as specific areas located on the surface of the framework;
(b) Material handling containers of claim 2(a) having optional sensors of various technologies for detecting the presence of material within the container;
(c) An enclosing cover for the framework of claim 2(a) having a locking mechanism and electronic sensor for detecting when the cover is raised and lowered;
(d) A back panel to the framework of claim 2(a) to provide connections of power, signaling devices, communication devices, switches, etc.
(e) a temperature tolerance of the framework of claim 2(a) such that the framework may be placed in a refrigerated environment or elevated temperature environment warm enough for biological matter such as found in the growing of biological cultures;

3. The electrical/electronic subsystem of claim 1 consisting of the following components:
(a) Printed circuit boards for the electronic/electrical components;
(b) A microprocessor;
(c) Data input technology for inputting information to the system;
(d) Display technology for outputting information;
(e) A power system using an external DC power source or a battery system which may or may not be coupled to a recharging system;
(f) optional electronic sensors embedded within the framework containers or embedded within the framework surface for sensing the presence of matter placed within a container or placed on the surface of the framework in designated areas;
(g) An optional container input device located in close proximity to each framework container;
(h) An optional container output device located in close proximity to each container;
(l) optional temperature sensing devices embedded within 0 or more framework containers and/or within the framework itself;
(j) Electronic communication technologies for communicating with remote computing systems and other frameworks;
(k) A device for nonvolatile storage of data;
(l) A real time clock for keeping track of the time and day of week;
(m) A device for setting a value readable by either the internal electronics or a remote system where said value indicates a unique identification value for a framework;

4. The software subsystem of claim 1 consisting of the following methods:
(a) An operating system for integrating and managing all the software methods;
(b) A sensor method for processing signals from the sensors in claim 3e;
(c) A method to send signals to devices associated with container output devices of claim 3h;
(d) A method to process signals associated with compartment input devices of claim 3g;
(e) A method for alerting a human operator to take action with respect to material within a container;
(f) Methods for controlling the time of day module of claim 3l;
(g) A method for password generation/verification and setting user access levels;
(h) A method for data encryption of user data and other sensitive information;
(l) a method for logging information into the nonvolatile storage devices of claim 3k;
(j) An electronic lock method for the electronic lock of claim 3f;
(k) A method to display messages to the devices of claim 3d;
(l) A method to input information through the devices of claim 3c:
(m) A menu system to allow an operator to program all the activities of the invention;
(n) A method to download software into program memory of the microprocessor for remote program updates;
(o) A method to network multiple systems together;
(p) A method of communication with a remote computing device;
(q) A method of communication with other frameworks;
(r) A database system to maintain information of the following nature but not limited to:
(1) User information such as name, age, address, social security number, medications, etc.
(2) Types of material allowable for the containers to include but not limited to:
(a) Prescription medications
(b) Homeopathic substances
(c) Supplements such as vitamins, etc.
(d) Chemicals
(e) Biological material

5. A distributed system using hardware and software networking technologies to network claim 1 subsystem into larger systems;

6. A scalable system using claim 1 subsystems to build ever more complex material management configurations to meet the requirements of different end user applications and markets.

7. Containers may hold matter of a solid nature or liquid nature when used with an appropriate physical container for the liquid.
